(19) United States
(12) Patent Application Publication
(10) Pub. No.: US 2004/0212818 A1
(43) Pub. Date: Oct. 28, 2004

(54) Program, method, and device for monitoring job

(75) Inventor: Seiji Harada, Hachioji-shi (JP)

Correspondence Address: BURNS DOANE SWECKER & MATHIS L L P, POST OFFICE BOX 1404, ALEXANDRIA, VA, 22313-1404, US

(73) Assignee: Konica Minolta Business Technologies, Inc., Tokyo (JP)

(21) Appl. No.: 10/802,778

(22) Filed: Mar. 18, 2004

(30) Foreign Application Priority Data
Apr. 11, 2003 (JP) 2003-108003

(51) Int. Cl. G06F 3/12; G06F 15/00; G06F 11/30

(52) U.S. Cl. 358/1.13; 358/1.15; 710/19

(57) ABSTRACT

A PC capable of functioning as job monitoring device makes a judgment before a printing job is transmitted to a printer which is to process said printing job as to whether the printing job can be processed on the printer or not based on the printing condition setup for the printing job and the printer's status information, and makes a display unit display the content of the judgment, if it is judged that the printing job cannot be processed.

This application is based on Japanese Patent Application No. 2003-108003 filed on Apr. 11, 2003, the contents of which are hereby incorporated by reference.

### BACKGROUND OF THE INVENTION

1. Field of the Invention

This invention relates to a program, a method, and a device for monitoring a job. The invention relates more specifically to a program, a method, and a device for monitoring a job in order to prevent inappropriate executions of printing job.

2. Description of the Related Art

In a printing system where a PC (personal computer) and a printer are connected on a network such as a LAN, the PC can transmit a printing job to the printer via the network to be printed by the printer.

In this case, a printer driver built into the operating system of the PC generates a printing job. More specifically, document data generated using a document generating application, a graphics generating application, or an image generating application is converted by the printer driver into printing data described in a printer language that can be processed by the printer. Thus, the printing job that includes the converted printing data and the printing condition such as a size and a kind of paper that are set up and desired by a user are transmitted from the PC to the printer. Upon receiving the printing job, the printer prints it according to the printing condition.

However, if the paper of the size and kind the user wants is not loaded in the paper feed tray of the printer, the printer generally stops the printing operation and prompts the user to change or add the paper by issuing an error notice. Thus, an inconvenience occurs that it holds up the printing operation until the paper is changed or added, preventing the execution of other printing jobs as well. In order to solve this problem, a technology has been proposed wherein a judgment is made on the transmission side as to whether the printing is printable by the printer and displays a notice when it is found to be unprintable in addition to the transmission of the printing job to the printer (refer to Unexamined Publication No. JP-A-2001-134388). This makes it possible for the user to know quickly that the job is unprintable, thus being able to avoid the situation of holding up the printing operation for a long time.

There is also a printer that forces printing using whichever paper existing in the printer even thought the paper may not be the one the user desired. In this case, the printing that the user does not want may be executed in vain. In order to solve this problem, a technology is proposed wherein the printer status information such as the size and kind of the paper loaded on the printer is reflected on the printing job setup screen by means of the printer driver thus to prevent the items that make the job unprintable from being selected (e.g., Unexamined Publication No. JP-A-2001-260492). This can prevent printing operation holdup or wasteful printing that the user does not want from being executed under an inappropriate printing condition.

However, although the user can recognize a particular job is not printable by means of the technology disclosed by said Unexamined Publication No. JP-A-2001-134388, it still cannot prevent the printing job from being transmitted to the printer so that the printing operation holdup and wasteful printing cannot be prevented.

On the other hand, the technology described in the Unexamined Publication No. JP-A-2001-260492 does not allow the user to select a particular printing condition although printing operation holdups and wasteful printing can be prevented. Moreover, if the user does not want to compromise on the selection of the size of paper, the user has to bear the inconvenience of going to the printer's location to change the paper and then select the desired printing condition. Furthermore, since it is necessary to have the printer's condition status reflected on the printing job setup screen, the PC obtains the printer's status information periodically at a specific time interval, which increases the communication burden of the system.

### SUMMARY OF THE INVENTION

It is an object of the present invention to provide a program, a method, and a device for monitoring a job, which are improved for solving the abovementioned problems.

It is a more specific object of the present invention to provide a program, a method, and a device for monitoring a job, which make it possible to execute job processing according to a processing condition of a user's preference easily and speedily by suppressing the increase of communication burden of a system and preventing a holdup of job processing such as printing and wasteful job processing.

According to an aspect of the invention, there is provided a program for causing a computer to execute a process comprising the steps of: 1) setting processing condition of a job; 2) acquiring status information, which is information concerning the status of a job processing device that processes said job; 3) judging whether said job can be processed by the job processing device according to said processing condition or not based on said processing condition and said status information before transmitting said job to the job processing device; and 4) notifying content of a judgment if it is judged that said job cannot be processed in step 3).

According to this invention, a user is capable of knowing the fact that a job cannot be executed by the job processing device under the designated processing condition prior to the transmission of the job with little communication burden on a system. Thus, the user becomes possible to choose either to instruct the computer to transfer the job nonetheless or to change the processing condition. Consequently, it is possible to avoid circumstances such as to transfer a job against the user's will to cause a holdup of job processing such as printing on the job processing device or to execute a wasteful processing of a job that the user does not want.

Moreover, since there is not a limitation on the selectable processing conditions in advance, the user can select a desired processing condition freely. Therefore, the user can instruct, for example, a job to be transmitted to the printer knowing that the paper of a desired size is not loaded at the printer, which is the job processing device, so that the printing cannot be done as is, but the user can go to the place where the printer is located to change the paper immediately. Thus, the user can bring back the printed matter according to the desired processing condition easily and quickly by making only one trip to the printer.

According to another aspect of the invention, there is provided a job monitoring method comprising the steps of: 1) setting processing condition of a job; 2) acquiring status information, which is information concerning the status of a job processing device that processes said job; 3) judging whether said job can be processed by the job processing device according to said processing condition or not based on said processing condition and said status information before transmitting said job to the job processing device; and 4) notifying content of a judgment if it is judged that said job cannot be processed in step 3).

According to still another aspect of the invention, there is provided a job monitoring device, comprising: a setting unit for setting processing condition of a job; an acquiring unit for acquiring status information, which is information concerning the status of a job processing device that processes said job; a judging unit for judging whether said job can be processed by the job processing device according to said processing condition or not based on said processing condition and said status information before transmitting said job to the job processing device; and a notifying unit for notifying content of a judgment if it is judged that said job processing is not executable.

The objects, features, and characteristics of this invention other than those set forth above will become apparent from the description given herein below with reference to preferred embodiments illustrated in the accompanying drawings.

### BRIEF DESCRIPTION OF THE DRAWINGS

FIG. 1 is a block diagram showing the constitution of a printing system wherein a job monitoring method according to an embodiment of the present invention is applied.

FIG. 2 is a block diagram showing the constitution of a PC shown in FIG. 1.

FIG. 3 is a block diagram showing functions related to a job monitoring program when the job monitoring program is installed on the PC.

FIG. 4 is a block diagram showing the constitution of a printer shown in FIG. 1.

FIG. 5 is a view of an example operating panel unit.

FIG. 6 is a flowchart for describing a process performed on the PC regarding the transmission of a printing job.

FIG. 7 is a flowchart for describing a process for judging appropriateness of printing condition of FIG. 6.

FIG. 8 is a diagram showing an example setting of printing condition.

FIG. 9 is an example display screen showing a judgment result according to an appropriateness judgment module.

FIG. 10 is a diagram showing an example screen for receiving a resetting request.

FIG. 11 is a flowchart for describing the process performed on the printer regarding the reception of a printing job.

### DETAILED DESCRIPTION OF THE PREFERRED EMBODIMENTS

The embodiments of this invention will be described below with reference to the accompanying drawings.

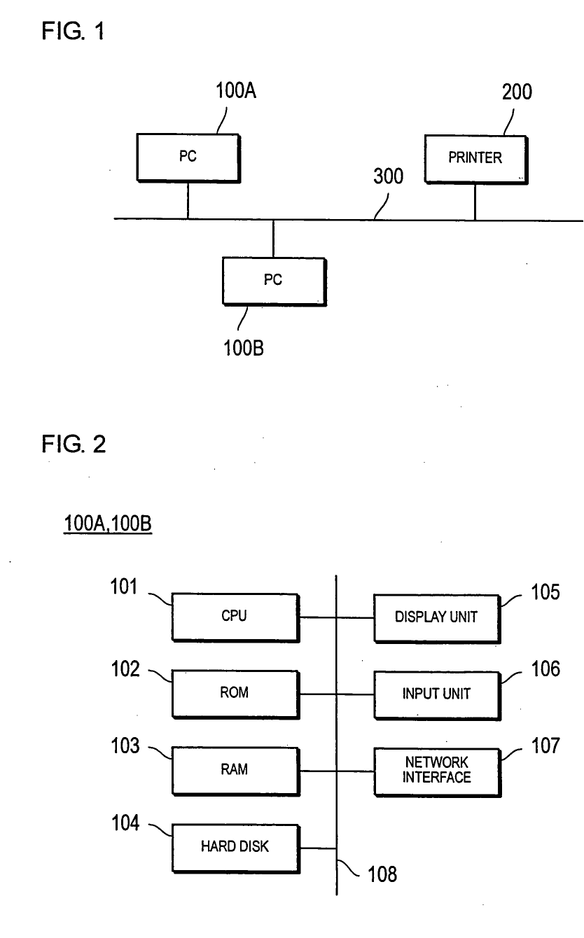

FIG. 1 is a block diagram showing the constitution of a printing system wherein a job monitoring method according to an embodiment of the present invention is applied.

As shown in FIG. 1, the printing system is equipped with PCs 100A and 100B, capable of functioning as job monitoring devices, and a printer 200 as a job processing device, which are connected communicably with each other via a network 300. The network 300 may be a LAN based on standards such as Ethernet®, Token Ring, FDDI, etc., or a WAN consisting of LANs connected by, for example, a dedicated line.

The types and the number of equipment to be connected to the network are not limited to those shown in FIG. 1. The printer 200 can be connected directly with the PC 100A or 100B (local connection) without going through the network 300. In this case, an interface and a protocol, such as USB and IEEE 1284, are used.

FIG. 2 is a block diagram showing the constitution of the PC 100A or 100B shown in FIG. 1. As shown in FIG. 2, the PC 100A or 100B includes a CPU 101 for controlling the entire device and executing various computations, a ROM 102 for storing programs and data, a RAM 103 for storing programs and data temporarily as a working area, a hard disk 104 as an external storage unit for storing various programs and data, a display unit 105 such as a liquid crystal display for displaying various information, an input unit 106 such as a keyboard and a mouse for entering various instructions, and a network interface 107 such as a LAN card for connecting to the network 300, all of which are interconnected via a bus 108 for exchanging signals.

The following is a description of a case wherein a printing job is generated by the PC 100A and transmitted to the printer 200.

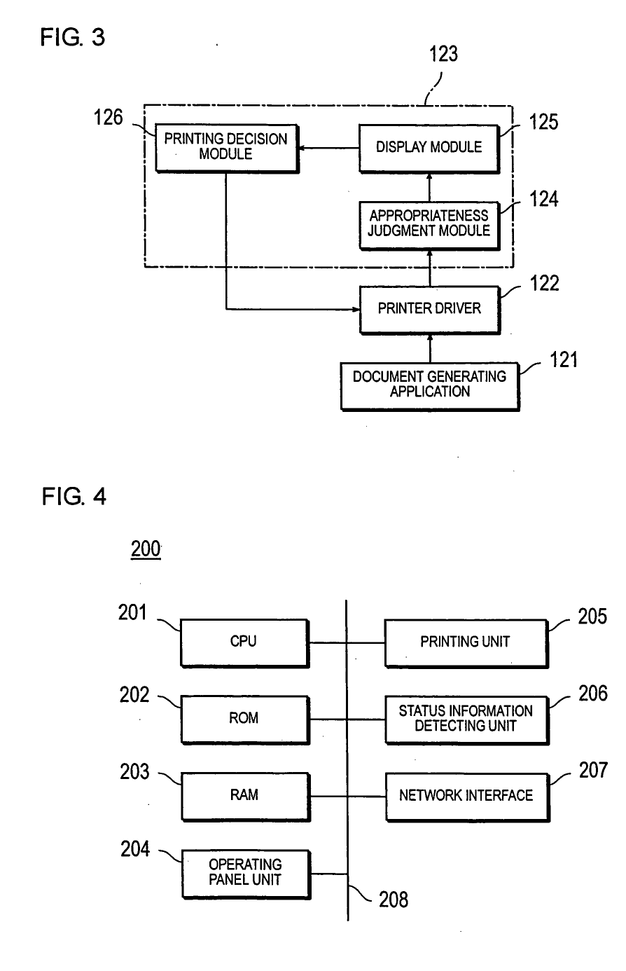

FIG. 3 is a block diagram showing functions related to a job monitoring program when the job monitoring program is installed on the PC 100A. The functions shown here are realized by the CPU 101 and a storage unit such as the RAM 103.

As shown in FIG. 3, a document generating application 121 for generating document data and a printer driver 122 for controlling the printer are installed in the PC 100A under the control of the operating system not shown here. In the present embodiment, a monitoring program 123 for a job is installed on the PC 100A for preventing an inappropriate printing job from being executed.

The document generating application 121 is a program for generating a word processor document as a document data in a specified format. The printer driver 122 can convert a document data prepared by the document generating application 121 into a printing data that can be processed by the printer 200. The printer driver 122 also can set up a printing condition based on the user's operation and generate a printing job that includes printing data and a printing condition.

The monitoring program 123 includes an appropriateness judgment module 124 that makes a judgment on whether the processing of a printing job is executable or not according to the printing condition set up, a display module 125 that notifies the contents of the judgment made by appropriateness judgment module 124, and a printing decision module 126 that decides to transmit the printing job having the printing condition set up.

FIG. 4 is a block diagram showing the constitution of the printer 200 shown in FIG. 1. As shown in FIG. 4, the printer 200 includes a CPU 201, a ROM 202, a RAM 203, an operating panel unit 204, a printing unit 205, a status information detecting unit 206, and a network interface 207, all of which are interconnected by a bus 208 for exchanging signals. Of the constituting elements of the printer 200, those that have the identical functions as the constituting members of the PC 100A are not described here to avoid duplications.

The RAM 203 can store the data received from the PC temporarily. The ROM 202 can store font information concerning fonts of characters. The printer 200 can be equipped with a hard disk as an external storage unit for storing various programs and data.

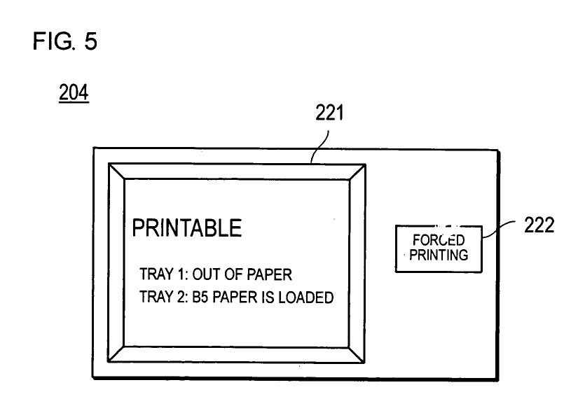

The operating panel unit 204 is used for displaying various information and entering various instructions. More specifically, as shown in FIG. 5, the operating panel unit 204 has a display panel 221 for displaying, for example, error information and a forced printing pushbutton 222 for forcibly printing a printing job which caused an error.

The printing unit 205 prints various data on a recording element such as paper using a known image forming process such as an electronic photography type process. Also, the printing unit 205 has the first tray, which is normally provided for loading paper to be used in image forming process, and the second tray, which is provided as an option (not shown)

The status information detecting unit 206 detects the status of the printing unit 205. In this embodiment, the status information detecting unit 206 can detect the presence or absence of paper loaded in the first tray and the second tray, paper sizes, and paper kinds. The paper sizes are A4, A3, B5, B4, etc., and the paper kinds are plain paper, OHP film, etc.

The PC 100A as well as the printer 200 can include a constitutional element other than those described above, or may not include a portion of the abovementioned elements.

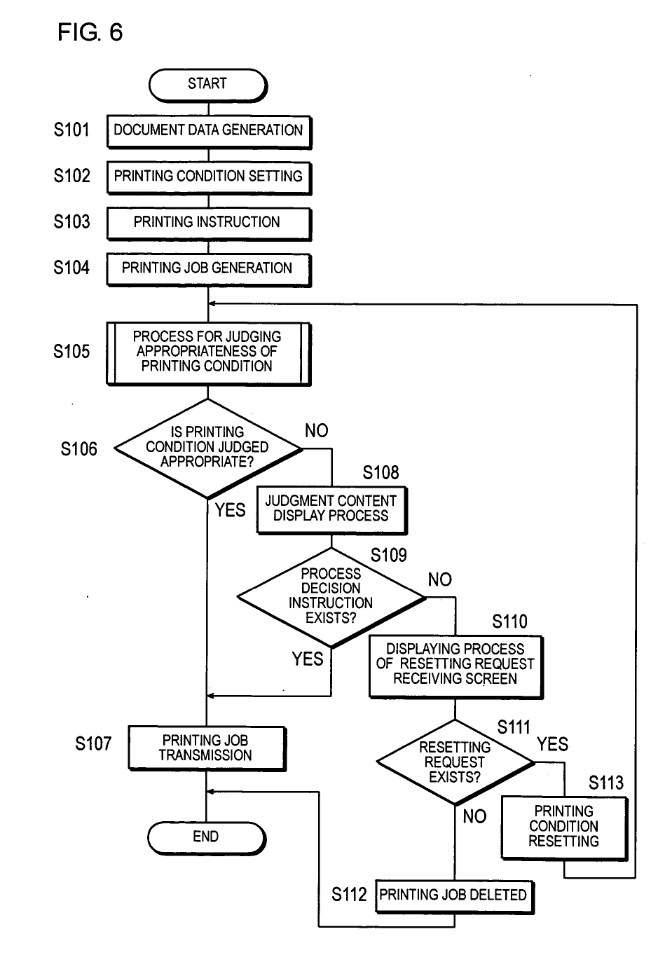

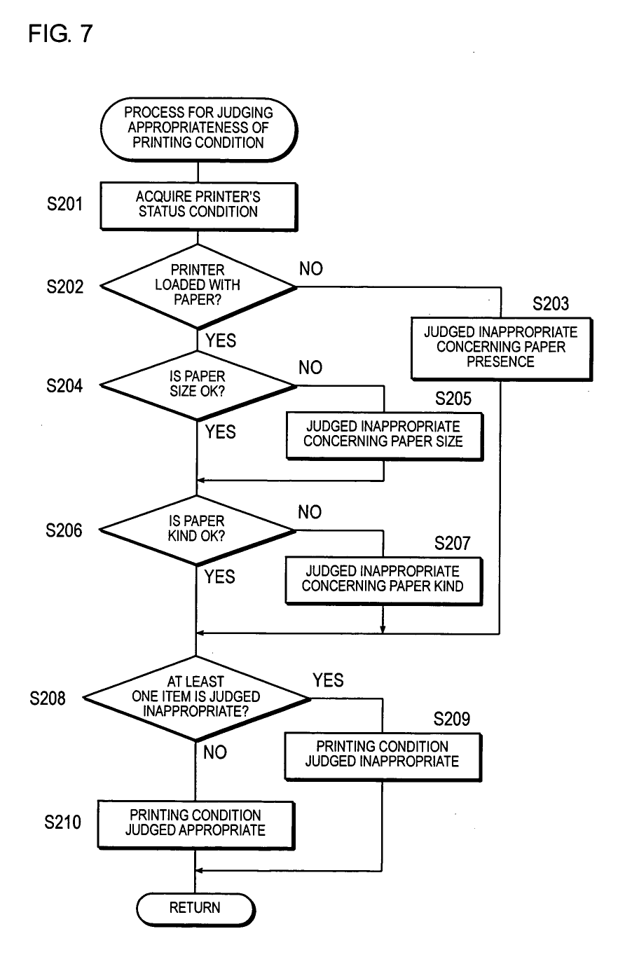

Next, the process performed on the PC 100A concerning the transmission of a printing job will be described with reference to FIG. 6 through FIG. 10. The algorithms shown in the flowchart of FIG. 6 and FIG. 7 are stored as a program in a storage unit such as the hard disk 104 of the PC 100A and executed by the CPU 101.

The document generating application 121 generates document data in a specified format based on a user's operation (S101).

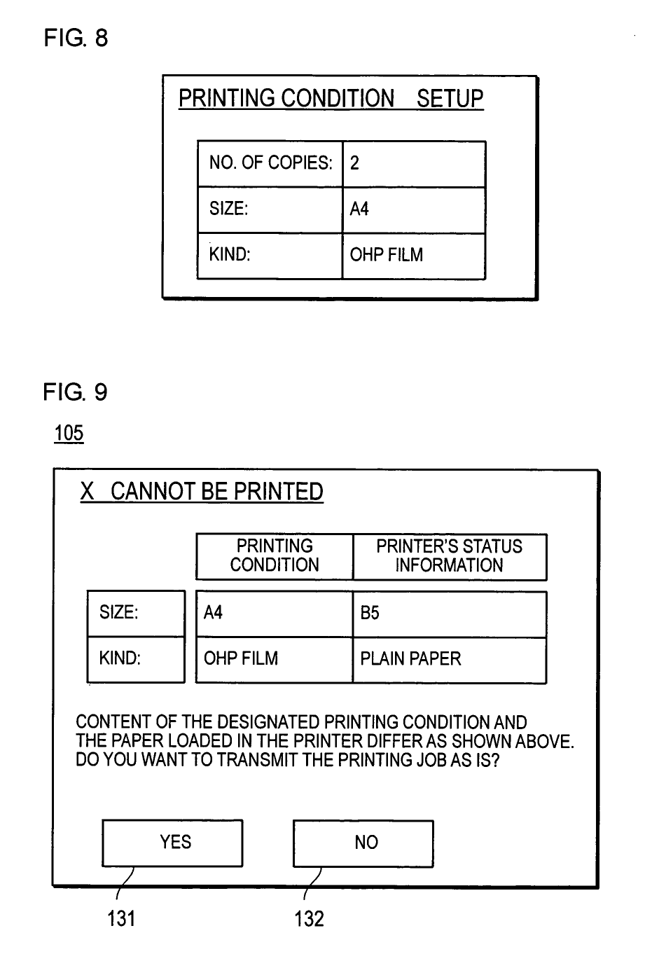

Then, the setup of a printing condition will be preformed (S102). More specifically, the document generating application 121 calls out the printer driver 122 based on the user's operation. The printer driver 122 displays a printing job setup screen (not shown) on the display unit 105 and sets up printing condition based on the user's operation. FIG. 8 is a diagram showing an example setting of printing condition. This setting of printing condition is stored in a storage unit such as the RAM 103 as text format data.

Next, the printing instruction is received (S103) In other words, an instruction is received through the setup screen for a printing job from the user for printing document data according to the setting of printing condition.

Upon receiving the printing instruction, the printer driver 122 converts the document data into printing data that can be processed by the printer 200 according to the designated printing condition and generates a printing job that includes the printing data and the printing condition (S104). The printing job thus generated is stored in the storage unit such as the RAM 103. If the paper size is specified, for example, as A4 as a part of the printing condition, the printing data is prepared as data that corresponds with the A4 size.

Then, the process for judging the appropriateness of the printing condition will be preformed (S105). In other words, the appropriateness judgment module 124 makes a judgment on whether the printing job process is executable on the printer 200 or not based on the printing condition that is set up, prior to the transmission of the printing job to the printer 200.

In the following, the process of judging the appropriateness of the printing condition in FIG. 6 is described with reference to FIG. 7.

As shown in FIG. 7, the status information concerning the printing unit 205 of the printer 200 is acquired from the printer 200 for each job (S201). However, the status information which has been received from the printer 200 and been stored in the RAM 103 can be acquired in step 201 as well. In this case, the reception of the status information from the printer 200 can be done when the PC 100A is booted up or periodically at a specific interval.

In step S202, the information concerning the presence or absence of paper loaded in the printer 200 is read from the acquired status information and a judgment is made as to whether any paper is loaded in the printer 200 or not. When paper is loaded in the printer 200 (S202: Yes), the program advances to step S204. If paper is not loaded in the printer 200 (S202: No), it is judged that the job is inappropriate concerning the presence/absence of paper (S203), the program advances to step S208.

In step S204, the information concerning the size of paper loaded in the printer 200 is read from the acquired status information and a judgment is made as to whether the size of the paper set up as printing condition matches with the size of the paper actually loaded in the printer 200 or not. If they match (S204: Yes), the program advances to step S206. If they do not match (S204: No), it is judged that the job is inappropriate concerning the size of paper (S205), the program advances to step S206.

In step S206, the information concerning the kind of paper loaded in the printer 200 is read from the acquired status information and a judgment is made as to whether the kind of the paper set up as printing condition matches with the kind of the paper actually loaded in the printer 200 or not. If they match (S206: Yes), the program advances to step S208. If they do not match (S206: No), it is judged that the job is inappropriate concerning the kind of paper (S207), the program advances to step S208.

In step S208, a judgment is made as to whether any item that is judged inappropriate exists or not. If there is at least one item that is judged inappropriate (S208: Yes), the designated printing condition is judged inappropriate as a whole (S209). In this case, information that the printing condition is inappropriate is set up as a result of the printing condition inappropriate judgment. On the other hand, if there is no item that is judged inappropriate (S208: No), the designated printing condition is judged appropriate as a whole (S210). In this case, information that the printing condition is appropriate is set up as a result of the printing condition inappropriate judgment.

The status information to be acquired in step S201 may include, other status information, for example, the presence/absence of a finisher that is capable of post processing such as staple processing and punch processing, or the presence/absence of consumable items such as toner. In this case, other information can be used for the process of judging the printing condition appropriateness.

Getting back to the description of the flowchart of FIG. 6, a judgment is made in step S106 as to whether the printing condition is judged appropriate or not based on the judgment result of the appropriateness of the printing condition set up in step S105. If the printing condition is appropriate (S106: yes), the program advances to step S107.

If the printing condition is judged to be inappropriate (S106: No), the display module 125 notifies the contents of the judgment made by the appropriateness judgment module 124 (S108). More specifically, the contents of the judgment made by the appropriateness judgment module 124 are displayed on the display unit 105 as shown in FIG. 9. In FIG. 9, the paper currently loaded in the printer 200 is indicated as B5 size plain paper according to the printer's status information, so that it does not match with the paper specified in the printing condition (A4 size OHP film) and it is shown that the job cannot be printed by the printer 200. Also, displayed on the display unit 105 are “Yes” button 131 for choosing to transmit a printing job that has a printing condition that is judged to be inappropriate to the printer 200 as is and “No” button 132 for choosing not to transmit a printing job that has a printing condition that is judged to be inappropriate.

Next, the printing decision module 126 makes a judgment as to whether an instruction for printing decision is received or not (S109). More specifically, a judgment is made as to which of “Yes” button 131 or “No” button 132 is operated. If a notice of printing decision is received, i.e., “Yes” button 131 is operated (S109: Yes), the program proceeds to step S107.

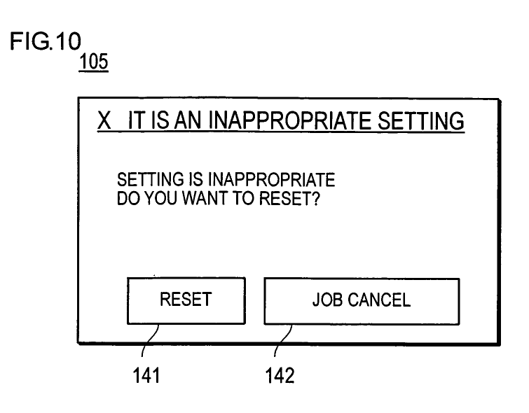

On the other hand, if “No” button 132 is operated (S109: No), the printing decision module 126 makes the display unit 105 display a resetting request receiving screen, which makes it possible to receive a request for change of the printing condition setting (S110). In other words, as shown in FIG. 10, display 105 displays the resetting request receiving screen having “resetting” button 141 for choosing to request a resetting of the printing condition and “job cancel” button 142 for canceling the transmission of a printing job to the printer 200.

Next, the printing decision module 126 makes a judgment as to whether a request for resetting of the printing condition is received (S111). More specifically, a judgment is made as to which of “Resetting” button 141 or “Job cancel” button 142 is operated.

When a request for resetting the printing condition is received, in other words, “Resetting” button 141 is operated (S111: Yes), resetting of the printing condition is performed (S113). More specifically, the printing decision module 126 calls out the printer driver 122. The printer driver 122 executes the resetting of the printing condition based on the user's operation. In this case, various settings can be done including the scale down printing in addition to the paper size change. After the resetting of the printing condition, the program returns to step S105.

On the other hand, if “Job cancel” button 142 is operated (S111: No), the printing decision module 126 calls out the printer driver 122, and the printer driver 122 erases the printing job generated in step S104 (S112), thus completing the series of process shown in FIG. 6.

In step S107, the printing job is transmitted to the printer 200. The printing data and the printing condition can be transmitted separately.

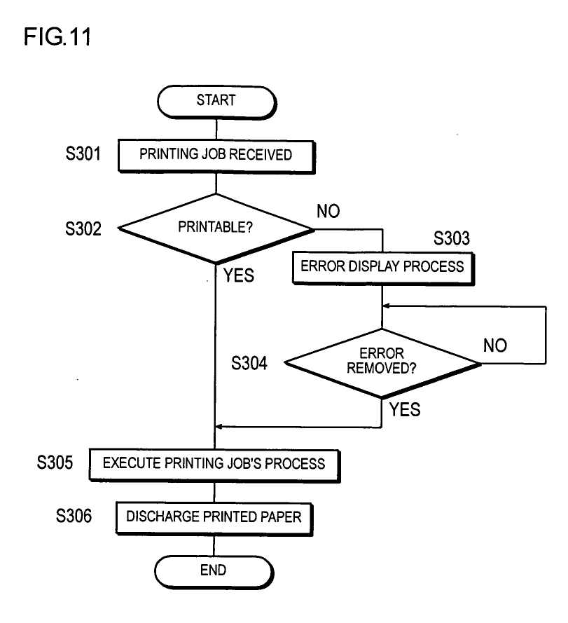

Next, the process performed on the printer 200 concerning the reception of a printing job will be described with reference to FIG. 11. The algorithm shown in the flowcharts of FIG. 11 is stored as a program in a storage unit such as the ROM 202 of the printer 200 and executed by the CPU 201.

First, the printer 200 starts to receive the printing job transmitted from the PC 100A (S301).

Next, a judgment is made as to whether the processing of the printing job according to the printing condition is executable on the printer 200 or not (S302). If it is judged that the printing job processing is executable (S302: Yes), the program advances to step S305.

If it is judged that the printing job processing is not executable (S302: No), the printer 200 interrupts the processing in the printing unit 205, and executes the display processing to display on the operating panel unit 204 that an error has occurred (S303).

Next, a judgment is made as to whether the generated error is removed or not (S304). For example, it is judged that the error is removed and the job has become printable when paper replenishment or exchange is made by the user or when the forced printing button 222 of the operating panel unit 204 (see FIG. 5) is pressed. When the force printing button 222 is pressed, the printing condition included in the printing job is changed to a specified printing condition which enables the processing. If the error is not removed (S304: No), the program returns to step S303 to continue the error display processing; if the error is removed (S304: Yes), the program proceeds to step S305.

In step S305, the received printing job is processed. In other words, the printing data is printed out by the printing unit 205 on the recording element such as paper according to the printing condition. The printed paper is discharged to a paper discharge tray (not shown) of the printer 200 (S306).

As can be seen from the above, according to the job monitoring method of the present embodiment, a judgment is made before a printing job is transmitted to a printer which is to process said printing job as to whether the printing job can be processed on the printer or not based on the printing condition setup for the printing job and the printer's status information, and the content of the judgment will be displayed on the display unit, if it is judged that the printing job cannot be processed.

Therefore, it is possible for a user to know prior to the transmission of the printing job that the printing cannot be done by the printer under the designated printing condition with little communication burden on a system. Thus, the user becomes possible to choose either to instruct the PC to transfer the printing job nonetheless or to change the printing condition. Consequently, it is possible to avoid circumstances such as to transfer a job against the user's will to cause the holdup of the printing operation on the printer or to execute a wasteful processing of a job that the user does not want.

Moreover, since there is not a limitation on the selectable printing conditions in advance, the user can select a desired printing condition freely. Therefore, the user can instruct, for example, a printing job to be transmitted to the printer knowing that the paper of a desired size is not loaded at the printer, so that the printing cannot be done as is, but the user can go to the place where the printer is located to change the paper immediately. Thus, the user can bring back the printed matter according to the desired printing condition easily and quickly by making only one trip to the printer.

It is obvious that this invention is not limited to the particular embodiments shown and described above but may be variously changed and modified without departing from the technical concept of this invention.

For example, various other types of computers such as a workstation or a server, can be used in stead of the PC in the above mentioned embodiment. Moreover, various other types of printing devices such as a copying machine or an MFP (Multi-Function Peripheral) can be used instead of the printer.

Moreover, although a printing system where a printing device such as a printer is used as a job processing device in the abovementioned embodiment, the invention is not limited to it but rather can be applied to systems where other types of job processing devices are used.

In the present invention, the job monitoring method or function for preventing the execution of an inappropriate job can be realized by a dedicated hardware circuit, or a computer programmed in such a manner. Said program can be provided either by a computer readable recording medium such as a flexible disk and a CD-ROM, or by being supplied on-line via a network such as the Internet. In this case, the program recorded in the computer readable recording medium is normally transferred to and stored in a storage unit such as a hard disk. Said program can also be provided as independent application software or can be built into the software, for example, a printer driver of the job monitoring device as a part of its function.

What is claimed is:

1. A program for causing a computer to execute a process comprising the steps of:
1) setting processing condition of a job;
2) acquiring status information, which is information concerning the status of a job processing device that processes said job;
3) judging whether said job can be processed by the job processing device according to said processing condition or not based on said processing condition and said status information before transmitting said job to the job processing device; and
4) notifying content of a judgment if it is judged that said job cannot be processed in step 3).

2. A program as claimed in claim 1, wherein
said job processing device is a printing device, and said status condition includes at least one of the presence or absence of paper loaded in the printing device, the size of the paper, and the kind of the paper.

3. A program as claimed in claim 1, wherein
in step 4), the content of a judgment in step 3) is displayed on a display unit.

4. A program as claimed in claim 1, wherein
change of the designated processing condition can be accepted if it is judged that said job cannot be processed in step 3).

5. A program as claimed in claim 1, wherein
said status information is acquired from the job processing device for each job in step 2).

6. A program as claimed in claim 1, wherein
status information received from the job processing device and stored in a storage unit in advance is acquired in step 2).

7. A computer readable recording medium on which the program as claimed in claim 1 is recorded.

8. A job monitoring method comprising the steps of:
1) setting processing condition of a job;
2) acquiring status information, which is information concerning the status of a job processing device that processes said job;
3) judging whether said job can be processed by the job processing device according to said processing condition or not based on said processing condition and said status information before transmitting said job to the job processing device; and
4) notifying content of a judgment if it is judged that said job cannot be processed in step 3).

9. A job monitoring method as claimed in claim 8, wherein
said job processing device is a printing device, and said status condition includes at least one of the presence or absence of paper loaded in the printing device, the size of the paper, and the kind of the paper.

10. A job monitoring method as claimed in claim 8, wherein
in step 4), the content of a judgment in step 3) is displayed on a display unit.

11. A job monitoring method as claimed in claim 8, wherein
change of the designated processing condition can be accepted if it is judged that said job cannot be processed in step 3).

12. A job monitoring method as claimed in claim 8, wherein
said status information is acquired from the job processing device for each job in step 2).

13. A job monitoring method as claimed in claim 8, wherein
status information received from the job processing device and stored in a storage unit in advance is acquired in step 2).

14. A job monitoring device, comprising:
a setting unit for setting processing condition of a job;
an acquiring unit for acquiring status information, which is information concerning the status of a job processing device that processes said job;
a judging unit for judging whether said job can be processed by the job processing device according to said processing condition or not based on said processing condition and said status information before transmitting said job to the job processing device; and
a notifying unit for notifying content of a judgment if it is judged that said job processing is not executable.

15. A job monitoring device as claimed in claim 14, wherein
said job processing device is a printing device, and said status condition includes at least one of the presence or absence of paper loaded in the printing device, the size of the paper, and the kind of the paper.

16. A job monitoring device as claimed in claim 14, wherein
said notifying unit causes the content of a judgment to be displayed on a display unit.

17. A job monitoring device as claimed in claim 14, wherein
change of the designated processing condition can be accepted if said judging unit judges that said job cannot be processed.

18. A job monitoring device as claimed in claim 14, wherein
said acquiring unit acquires the status information from the job processing device for each job.

19. A job monitoring device as claimed in claim 14, wherein
said acquiring unit acquires the status information received from the job processing device and stored in a storage unit in advance.
